(19) United States
(12) Patent Application Publication
(10) Pub. No.: US 2025/0312999 A1
(43) Pub. Date: Oct. 9, 2025

(54) SEQUENTIALLY STRETCHED BIAXIALLY ORIENTED OPAQUE FILM CONTAINING POLYOLEFIN AND SILICA GEL VOIDING AGENT

(71) Applicant: TAGHLEEF INDUSTRIES INC., Newark, DE (US)

(72) Inventors: Andrew WILKIE, Avondale, PA (US); Anthony DENICOLA, Old Lyme, CT (US); Eric PROPST, Terre Haute, IN (US)

(21) Appl. No.: 18/630,660

(22) Filed: Apr. 9, 2024

(51) Int. Cl. B32B 27/18; B32B 27/08; B32B 27/32

(52) U.S. Cl. CPC B32B 27/18; B32B 27/08; B32B 27/32; B32B 2250/05; B32B 2250/242; B32B 2264/1021; B32B 2264/1022; B32B 2264/303; B32B 2270/00; B32B 2307/4026; B32B 2307/41; B32B 2307/518; B32B 2307/72; B32B 2307/724; B32B 2439/46; B32B 2519/00

(57) ABSTRACT

A multilayer film is disclosed, which has a plurality of layers including a thickest layer with 1 to 25 wt. % of a silica gel having an average particle size of 1 to 10 microns, and at least 50 wt. % of at least one polyolefin, wherein: (a) the thickest layer is voided by the silica gel; and (b) the multilayer film is a biaxially oriented film having an opacity greater than 10 and a density of less than 1 g/cc. Labels and flexible packages including the multilayer film, and methods for making them are also disclosed.

### BACKGROUND OF THE INVENTION

### 1. Field of Invention

This invention relates to shrink films suitable for use in packaging, and particularly to multilayer films containing voiding agents.

### 2. Description of Related Art

There is a constant need to reduce the mass of waste being discarded into the environment. One mechanism to achieve that goal is to reduce the thickness of packaging films. In the area of packaging films, that are often single use and discarded, there is a desire to reduce the mass of opaque films going to the landfill. One means to reduce mass has been to reduce film thickness. However, as the film is made thinner, mechanical properties like stiffness suffer.

Over three decades ago, voiding agents were introduced to reduce density but maintain thickness. Voided films are now a dominant market segment.

Commercially, voided film is typically produced by incorporating into a film heavy dense mineral filler with a small particle size (e.g., having a diameter of 1 to 5 microns). The polymer from which the film is formed is loaded with 10 to 20 wt. % mineral filler and cast. The chilled casting is then reheated and oriented between offset driven rolls in the machine direction. This sudden pull of over 400% in the machine direction induces cracks or separation between the polymer and mineral filler. When the film is subsequently stretched in the transverse direction air voids are formed around the particles. The resulting film has lower density, typically between 0.8 and 0.5 g/cc.

Voiding agents commonly include minerals like CaCO₃, which has dominated the commercial market for decades. However, the patent literature is full of suggestions of other voiding agents besides calcium carbonate, including, e.g., barium carbonate, glass beads, silicon oxide, aluminum, ceramic spheres, iron, alumina, clay, talc, and titania. See, e.g., US20210339510 A1. These minerals are taught as interchangeable, and the mechanism of void formation would suggest this assumption is reasonable. However, to our surprise this is not the case.

One issue with a dense mineral filler is that as the loading of filler in the film increases, the mass of the filler increasingly offsets the weight reduction afforded by the formation of air voids resulting in overall film density that is less than ideal. Commercial film processing is limited to a density greater than 0.5 g/cc.

Moreover, as the loading of filler is increased, there is a reduction in film mechanical properties as the polymer content of the film is reduced. This is particularly observed in the z-axis failure of the film, where the film tears through the core of the film splitting in half. High z-axis strength is critical to maintain the integrity of packaging film and labels.

Polymer voiding agents have been used in place of higher density mineral fillers to reduce the overall film density of voided films. For example, polybutylene terephthalate (PBT) is a lower density organic voiding agent that can facilitate mass reduction of films. However, PBT is difficult to use owing to a negative tendency to decompose on the metal surfaces of processing equipment and a negative reaction to other additives in the film like TiO₂. PBT dispersion particle size is sensitive to screw design, rom, screw backpressure, and throughput rate.

Hollow glass spheres are taught as a voiding agent that may enable lower density films. However, as the shell wall is made thin, they will have a tendency to break as the shells grind on the metal surfaces of a rotating screw used to extrude the polymer during production of film.

Other potential low density voiding agents that have been taught include carbon, activated carbon and graphite. These agents produce a black film. A black film is not acceptable for packaging and label films because the need to print on the film is virtually universal.

A more exotic approach to achieving low density high strength films is to use foaming agents. This approach results in poor film uniformity and makes it particularly difficult to control the void size and distribution. It is also problematic for most commercially important voided films with skin layers over the voided core not being voided. This makes it impossible to uniformly release the foaming agent gas in the core of the film.

Beta nucleation is a mechanism to produce very small voids between polymer crystals. This process can result in very desirable low-density film. However, the process requires extremely low processing speeds and high cast temperatures, which is impractical for packaging and label film. Additionally, the ability to build strength through the orientation of molecules in the film is limited, resulting in low strength film.

Consequently, there is a long-standing need in the industry to reduce the density of film while maintaining or improving strength and opacity.

Although certain forms of silica have been used as voiding agents in films, other forms, such as silica gels, are not known to be useful for said purpose.

Silica gels are used in films for purposes other than voiding. For example, it is known to use silica gels as anti-blocking agents and/or anti-slip agents. See, e.g., U.S. Pat. Nos. 4,741,950, 5,397,635, 5,972,496, 6,242,084 B1, 6,455,150 B1, U.S. Pat. No. 6,572,960 B2, WO 9849003 A1, WO 02090104 A1, WO 9414606 A1 and EP 1919705 A1.

U.S. Pat. No. 7,015,270 discloses a water-based coating formulation patent in which silica gel is used as a pigment.

WO 20200131709 A2 discloses extruded multilayer films comprising an extruded top layer comprising a blend of one or more polyolefins and 5 wt. % adsorbent silica, which is preferably a silica gel. Adsorbent silicas, such as silica gel, are taught to provide improved printability. They are not taught to be voiding agents.

Thus, there is no suggestion in the prior art to use silica gel as a voiding agent. Indeed, U.S. Pat. No. 5,397,635 teaches silica gel can function as an anti-blocking agent in the skin without imparting objectionable haze to the structure, which suggests that silica gel does not function as a voiding agent.

Accordingly, it is desired to provide voiding agents that address the deficiencies of prior art voiding agents. It is further desired to provide voided biaxially oriented films prepared from improved voiding agents in a sequential stretch process. It is still further desired to provide such films and packages thereof that are less dense and more durable than prior art films and packages.

All references cited herein are incorporated herein by reference in their entireties.

### BRIEF SUMMARY OF THE INVENTION

Accordingly, a first aspect of the invention is a multilayer film comprising a plurality of layers including a thickest layer comprising 1 to 25 wt. % of a silica gel having an average particle size of 1 to 10 microns, and at least 50 wt. % of at least one polyolefin, wherein: (a) the thickest layer is voided by the silica gel; and (b) the multilayer film is a sequentially stretched biaxially oriented film having an opacity greater than 10 and a density of less than 1 g/cc.

In certain embodiments, the polyolefin is predominantly polypropylene.

In certain embodiments, the at least one polyolefin is at least one member selected from the group consisting of polypropylene, polyethylene, polypropylene/polyethylene copolymer, polypropylene/polyethylene/polybutylene terpolymer, butene-1 copolymer with ethylene and styrenic triblock (S-E/B-S) copolymer elastomers.

In certain embodiments, the multilayer film has a density less than 0.85 g/cc.

In certain embodiments, the multilayer film has a z-axis strength greater than 100 g/in.

In certain embodiments, the multilayer film has a z-axis strength greater than 200 g/in and a density less than 0.7 g/cc.

In certain embodiments, the multilayer film has a z-axis strength greater than 400 g/in.

In certain embodiments, the multilayer film is white with an opacity greater than 80, and the thickest layer contains 2-8 wt. % of the silica gel.

In certain embodiments, the silica gel adsorbs less than 8% moisture at 80% relative humidity.

In certain embodiments, the multilayer film further comprises titanium dioxide.

In certain embodiments, the multilayer film comprises a combination of voiding agents including at least one additional voiding agent in addition to the silica gel, wherein an average density of the combination of voiding agents in the multilayer film is less than 1 g/cc.

In certain embodiments, a surface of the multilayer film is treated or coated.

A second aspect of the invention is a label comprising the multilayer film of one or more of the above embodiments.

In certain embodiments, the label is a wash off label.

In certain embodiments, the label is a roll on shrink on (ROSO) label.

A third aspect of the invention is a flexible package comprising the multilayer film of one or more of the above embodiments.

In certain embodiments, the flexible package is a bag having walls formed by the multilayer film.

### BRIEF DESCRIPTION OF SEVERAL VIEWS OF THE DRAWINGS

The invention will be described in conjunction with the following drawing, wherein:

FIG. 1 is a graph of density against percent voiding agent.

FIG. 2 is a graph of opacity against percent voiding agent in the core.

FIG. 3 is a graph of Z-axis strength against density.

FIG. 4 is a graph of density against percent voiding agent in the core.

### DETAILED DESCRIPTION OF PREFERRED EMBODIMENTS OF THE INVENTION

### Glossary

Throughout the description, where the invention is specified as “having”, “including” or “comprising” (or other conjugations thereof) a feature, it should be understood that these are open terms such that the invention may include additional features. In addition, where an embodiment of the invention is specified as having, including or comprising a feature, the invention also encompasses alternative embodiments wherein additional features are strictly excluded (as indicated by the use of the transitional phase “consisting of”) and alternative embodiments wherein additional features are excluded only if they will have a material effect on the invention (as indicated by the use of the transitional phrase “consisting essentially of”).

Where an element or component is said to be included in and/or selected from a list of recited elements or components, it should be understood that the element or component can be any one of the recited elements or components and can alternatively be selected from the group consisting of any combination of two or more of the recited elements or components.

The use of the singular herein includes the plural (and vice versa) unless specifically stated otherwise. Thus, the terms “a” and “an” mean “at least one” unless stated otherwise.

The term “substantially free of” refers to an inconsequential amount of a stated ingredient or thing. “Free of” refers to no detectable amount of the stated ingredient or thing.

The dimensions and values disclosed herein are not to be understood as being strictly limited to the exact numerical values recited. Instead, unless otherwise specified, each such dimension is intended to mean both the recited value and functionally equivalent range surrounding that value. For example, a volume of “40 ml” is intended to mean “about 40 ml”. Where the term “about” is used before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions can be conducted simultaneously.

Unless specified otherwise the following terms shall have the specified meanings set forth below:

“Ambient” refers to surrounding conditions at about one atmosphere of pressure, about 50% relative humidity and about 25° C. Ambient conditions should be understood to apply unless otherwise specified.

“Olefin polymer” means a homopolymer, copolymer or terpolymer in which all of the monomer units in such polymers are olefins.

“Propylene polymer” means a propylene homopolymer, or a copolymer or a terpolymer in which the predominant monomer component by weight is propylene.

“Propylene terpolymer” or “polypropylene terpolymer” means a propylene, ethylene, butene terpolymer in which propylene is the predominant monomer unit by weight.

“Propylene ethylene copolymer” or “polypropylene ethylene copolymer” and “propylene butene-1 copolymer” or “polypropylene butene-1 copolymer” means propylene ethylene or propylene butene-1 copolymer in which propylene is the predominant monomer unit by weight.

“Polypropylene homopolymer”-includes, in addition to a homopolymer, a polypropylene ethylene copolymer in which the percentage of ethylene is so little that it does not adversely affect the crystallinity or other properties of the propylene homopolymer. These copolymers are referred to as “mini-random” copolymers and have a percentage of ethylene, by weight of the copolymer, of 1% or less.

“Percent shrinkage” in referring to the shrinkage of a film or a label formed from such film is calculated in accordance with the following formula:

(Dimension prior to shrinkage−Dimension after shrinkage)×100/Dimension prior to shrinkage

“Density” of the film or label formed therefrom is determined by the displacement procedure of ASTM D792 test method.

“Stiffness”, “Flexural Stiffness” or “Flex Stiffness” measures the stiffness or bending resistance of plastic films using an MTS/Sintech Q-Test Model QT-5 or similar instrument, a 2N (200 g) load cell, a triangular shaped stirrup attached to the load cell and a film holding fixture with a 1 inch wide channel which holds the film in the form of an arc. Film sample length is 4 inches with width between 1 and 4 inches. Crosshead speed is 12 inches/min with maximum compressive force required to bend the film sample at the center of the arc being measured. Results are reported as grams per inch width (peak grams divided by sample width in inches).

“Opacity” of a film or label formed therefrom is determined in accordance with TAPPI T425 test method.

“MD” and “TD” refer to the machine direction and the transverse direction in the manufacturing process, respectively.

“Measured Thickness” is determined by cross-section microtoming a thin slice of the film and viewing the cross-section under a scanning electron microscope with a calibrated image scale to determine individual layer thicknesses of the multilayer film.

“Z Axis Strength” is the measure of the inter-laminar strength of a film specimen and covers measurement of the forces exerted when a specimen is pulled apart in the Z direction (i.e., through the cross-section). Scotch 610 tape (1 inch width and 8 inches long) is applied to both sides of the film specimen with moderate pressure to ensure that the tape has adhered to the sample on both sides. The two tapes are initially pulled apart manually to initiate inter-laminar failure. Once the z-axis failure has been initiated, the two tape tabs of the sample are placed in a MTS Q-Test/1 L tensile tester or similar instrument (25N cell) and separated at a cross head speed of 35 inches/minute. The peak and peel force is recorded and reported as grams per inch of width. If the sample does not initiate or fail by interlaminar separation, it is reported as “could not delaminate”

“Yield” is the coverage in square inches/pound (in.²/lb.) and is determined in accordance with ASTM D4321 test method.

The terms “biaxial” and “bidirectional” are synonymous terms for specifying the direction of orientation of films in which the draw ratio in both the MD and TD directions is greater than 2.0×.

All percentages and ratios are calculated by weight unless otherwise indicated and are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Advantages of the Invention

A surprisingly effective voiding efficiency of silica gel as an opacifying agent for sequentially stretched polyolefin film has been identified. The high efficiency relative to other voiding agents makes it possible to 1) reduce density at similar film strength, 2) produce film with high strength and very low density, 3) produce opaque films with very low additive levels.

The invention is a polyolefin film composition that enables a white opaque film that can be formulated to enable very low density, or very high strength at a density achieved with typical voiding agents. This capability can enable the reduction of mass to the waste stream associated with packaging film.

### Films of the Invention

A first aspect of the invention is a film comprising at least one polyolefin and a silica gel effective to produce voiding in the film so as to make the film opaque.

The film is preferably a multilayer film structure (or laminate) of two or more layers, such as, e.g., a laminate of 2, 3, 4, 5, 6, 7, 8, 9 or 10 layers. Particularly preferred embodiments include a core (or base) layer having a skin layer on at least one face of the core layer. Layers between the skin and core layers are also within the scope of the invention. Specific examples of suitable arrangements of layers in a multilayer film of the invention include but are not limited to the following five embodiments:

| 1 | 2 | 3 | 4 | 5 |
|---|---|---|---|---|
| Skin | Skin | Skin | Skin | Skin |
| Base | Intermediate | Core | Intermediate | Intermediate |
| | Base | Skin | Core | Core |
| | | | Skin | Intermediate |
| | | | | Skin |

The inventive multilayer films are preferably sequentially stretched and biaxially oriented.

The core layer is preferably the thickest layer of the multilayer film. The core layer preferably has a thickness of 5-100 microns or 10-25 microns for packaging films and 30 to 60 microns for labels. The core layer preferably comprises a silica gel and at least one polymer (e.g., a polyolefin). The core layer can optionally comprise at least one additive.

### Silica Gel

The term “silica” refers to the compound silicon dioxide and is sometimes referred to as silicon oxide. The silica used as a voiding agent according to the invention is silica gel. The silica family is quite large with family members having very different physical characteristics that make silicas other than silica gel unsuitable for use as voiding agents.

The two broadest categories are amorphous and crystalline silica. Crystalline silica includes quartz, cristobalite and tridymite. Amorphous silicas include natural, incidental and synthetic. Natural amorphous silicas include diatomite and calcined silica. The incidental silicas include fused and fumed silica. These silicas generally have a density of approximately 2 g/cc, which is too high for floatability. The fumed silica has a particle size that is unacceptable for film manufacture.

Synthetic silicas are generally classified as either thermal or wet. Thermal or pyrogenic silicas include glasses (high sodium, leaded, colored, tempered). Glasses commonly have a density of greater than 2 times that of polypropylene. These thermal silicas also include silicates that are commonly alloyed with other atoms to produce zeolites. These structures have very small pore sizes. The small pores adsorb and condense water through a process called capillary condensation. This entrapped water is detrimental to the polymer extrusion and stretching process associated with making film. The entrapped water escapes as the molten polymer emerges from a high pressure die, causing holes in the casting and preventing the formation of film.

Wet silicas include precipitated silica, colloidal silica, aerogel, and silica gel. Precipitated silica is commonly used as an anti-block additive in film production. It is dense and does not cause voiding. In fact, it is commonly used in the production of clear films as an anti-blocking agent where it is observed to not cause haze, which would be associated with voiding. Colloidal silica particle size is far too small to be useful in a polymer extrusion process. Additionally, the particle size is too small to expect voiding and cavitation as commonly seen with TiO₂ where the particle size is on the order of 200 nm. Aerogel offers low density and large pore size, however, the process includes precipitation from a super critical fluid condition, makes the cost of the raw material far too high to consider in a packaging film.

Of all the silicas, silica gel is the most desirable classification for use as a voiding agent, owing to its particle size and internal porosity creating a low density mineral agent. However, certain silica gels are unsuitable or less preferred for use as voiding agents. If the pore size of the silica gel is too small, water is adsorbed and condensed within the pores through capillary condensation. These desiccant grade silicas are referred to as A, B or C type which is defined by how the silica absorbs and internally condenses water as a function of humidity in the ambient air. Desiccant grade silica gel is very common. If the silica adsorbs through capillary condensation more than 10% of its mass at a relative humidity level of 80%, then the entrapped water will have a negative effect on the extrusion of polymer and formation of oriented film. The water will create large holes in the polymer casting as it exits the hot die when the pressure is suddenly relieved from high pressure piping and die as the casting is formed at only atmospheric pressure. The holes prevent uniform stretching and prevent the fabrication of film.

The silica gel preferred for use in this invention has an average particle size of 1 to 10 microns, and more preferably 3 to 7 microns. The silica gel preferably adsorbs less than 8% moisture at 80% relative humidity. More preferably, the moisture adsorption is less than 5% at 80 relative humidity. This feature is commonly associated with silica gels with an average pore size of greater than 6 nm, which is therefore the preferred average pore size of silica gels of the invention. More preferably, the average pore size is greater than 10 nm, and still more preferably greater than 15 nm. Average pore size beyond 25 nm is unusual and generally very expensive. Thus, the average pore size is preferably 6-25 nm or 10-25 nm or 15-25 nm. All silica gel is porous and therefore the particles are inherently less than 0.8 g/cc in density, which is a helpful feature in achieving a floatable composition with low voided density. Surprisingly, the silica gel also causes cavitation when included in a polyolefin film core, further reducing the density of the composite films.

Silica gel loading in the core can be from 1 to 30 wt. %, and is preferably from 3 to 15 wt. %. The higher levels of silica gel enable the addition of higher density opacifying agents like titanium dioxide in the core or skin layers.

Silica gel can be used as the sole voiding agent in the film or can be used in a combination of voiding agents including at least one additional voiding agent in addition to the silica gel. It is preferred to exclude carbon black from the film due to its negative impact on whiteness. Preferably, the average density of the combination of voiding agents in the multilayer film is less than 1 g/cc. The average density of the combination of silica gel (SG) and additional voiding agent(s) (AVA) can be determined by multiplying the density of each voiding agent by the volume of each voiding agent in the combination, summing the results and then dividing the sum by the sum of all the volumes.

Silica gel can also be used in conjunction with other opacifying agents or colorants like TiO₂ in one or more layers of a film.

### Polymers

Polymers make up the majority of the core layer, and preferably constitute 60-95 wt. % of the core, or 70-91 wt. % of the core. Polymers suitable for use in the core layer include but are not limited to polypropylene, propylene copolymers, ethylene copolymers, terpolymers with ethylene and butene. Suitable polyolefins can be propylene based polymers, such as isotactic crystalline polypropylene homopolymers and “mini-random” isotactic crystalline ethylene propylene copolymers. Mini-random propylene homopolymers constitute a class of ethylene propylene copolymers in which the ethylene content is fractional, i.e., less than 1 wt. % typically. Suitable examples of crystalline propylene homopolymers are Total Petrochemicals 3271, 3274, and 3373HA; Phillips CH016, CH020 and CH035; and Braskem FF018. These resins can also have melt flow rates of about 0.5 to 5 g/10 minutes at 230° C., a melting point of about 160-165° C. and a crystallization temperature of about 108-126° C., a heat of fusion of about 86-110 J/g, a heat of crystallization 105-111 J/g, and a density of about 0.9 g/cc. Higher isotactic content polypropylene homopolymers (high crystalline) may also be used. Suitable examples of these include Total Petrochemicals 3270 and 3272, Braskem grade HR020F3, and Phillips 66 CH020XK.

Other suitable polyolefins can be propylene-containing copolymers, such as ethylene-propylene copolymers, propylene-butene copolymers, ethylene-propylene-butene copolymers, including propylene containing impact copolymers and blends thereof. It can be contemplated to blend propylene homopolymers, mini random homopolymers and copolymers as desired. Exemplary propylene containing copolymers can include Total Petrochemicals Z9421 ethylene-propylene random copolymer elastomer of about 5 MFR with 7% ethylene content, Total Petrochemicals 8473 ethylene propylene random copolymer with 4.5% ethylene content, Sumitomo Chemical SPX78R1 ethylene propylene butene random copolymer with 9.5 MFR with 1.5% ethylene, and 16% butene polymer, or ExxonMobile Chemical Vistamaxx ethylene propylene random copolymer elastomer such as grade 3980FL. Other suitable propylene based copolymers and elastomers include but are not limited to metallocene catalyzed thermoplastic elastomers like ExxonMobil's Vistamaxx 3000 grade or Dow Chemicals Versify 3300 grade. Also included is Mitsui Chemicals Tafmer grades XM7070 and XM7080 metallocene catalyzed propylene butene random elastomers.

Other olefins that can be considered are ethylene homopolymer such as high density. Medium density, and low density polyethylene. Representative of these are Total Petrochemical HDPE 9658 or 9260.

In addition, these propylene based resins by also include additives such as antiblocking agents, and or slip agents. The amount of the inorganic antiblocking agent may be optionally added up to 10,000 ppm to the film skin or intermediate layers. As desired for film handling purposes, winding, anti-blocking, and friction control. Suitable antiblock agents comprise those such as inorganic silicas, sodium calcium alumino silicate, cross linked silicone polymers such as polymethylsilsesquioxane, and polymethyl methacrylate spheres. Typical sizes of these range for 1 to 10 microns. Slip agents such as fatty amides and or silicone oils can also be added in one or more of the film layers.

### Polypropylene Terpolymers and Copolymers

Polypropylene terpolymers are commercially available from LyondellBasell, Houston, TX under the trade name ADSYL. The following is a non-exclusive listing of exemplary polypropylene terpolymers that are, or that may be usable in the core layers of the films in this invention:

LyondellBasell ADSYL 6C30F is a Ziegler-Natta catalyzed random terpolymer of propylene, ethylene, and butene with the propylene being the predominant component, by weight, of the terpolymer. ADSYL 6C30F has a MFR (230/2.16) of 5.5 dg/min, a SIT of 98° C., and a DSC peak melting point of 126° C.

ADSYL 7410XCP also is a terpolymer of propylene, ethylene and butene, with propylene being the predominant component, by weight, and which has a MFR (230/2.16) of 5.5 dg/min, a SIT of 75° C., and a DSC peak melting point of 125° C. and ADSYL 5C30F with a melt flow rate of 5.5 dg/min (230° C., 2.16 kg), a SIT of 105° C., and a DSC peak melting point of 132° C.

Polypropylene copolymers with ethylene or butene-1 as co-monomers are commercially available from a number of sources, including LyondellBasell in Houston, TX, Ineos Olefins & Polymers USA headquartered in League City, TX, Braskem America Inc. headquartered in Philadelphia, PA and Total USA headquartered in Houston, TX. The following is a non-exclusive listing of exemplary polypropylene copolymers that are, or that may be usable in the core layers in the films of this invention:

INEOS ELTEX P KS407 is a copolymer of propylene and about 4.0% ethylene, with propylene being the predominant component, by weight, and which has a MFR (230/2.16) of 5 dg/min, and a DSC peak melting point of 134° C.

BRASKEM DS6D82 is a copolymer of propylene and about 4.0% ethylene, with propylene being the predominant component, by weight, and which has a MFR (230/2.16) of 7 dg/min, and a DSC peak melting point of 134° C.

TOTAL 8573 is a copolymer of propylene and ethylene with propylene being the predominant component, by weight; having a MFR (230/2.16) of 6.8 dg/min and having a DSC peak melting point of approximately 135° C.

LyondellBasell ADSYL 7416 XCP is a copolymer of propylene and ethylene with propylene being the predominant component, by weight; having a MFR (230/2.16) of 7.5 dg/min and having a DSC peak melting point of approximately 133° C.

LyondellBasell ADSYL 7415 XCP is a copolymer of propylene and ethylene with propylene being the predominant component, by weight, having a MFR (230/2.16) of 0.9 dg/min and having a DSC peak melting point of approximately 133° C.

LyondellBasell ADSYL 3C30F HP is a copolymer of propylene and butene-1 with the propylene being the predominant component, by weight, of the copolymer and which has a MFR (230/2.16) of 5.5 dg/min, and a DSC peak melting point of 137° C.

### Polybutene-1 Copolymer

Polybutene-1 copolymers are commercially available from LyondellBasell, Houston, TX under the trade names KOATTRO and TOPPYL. LyondellBasell KOATTRO DP8310M and TOPPYL DP8220M are Polybutene-1 copolymers with ethylene.

KOATTRO DP8310M has a MFR (190/2.16) of 3.5 dg/min, a melting point of 94° C., and a density of 0.897 g/cm³, and is characterized as having a high ethylene content. In this copolymer the ethylene content is less than 50% by weight thereof, and most preferably is less than 15% by weight.

TOPPYL DP8220M has a MFR (190/2.16) of 2.5 dg/min, a melting point of 97° C., and a density of 0.901 g/cc and is characterized as having a medium ethylene content. In this copolymer the ethylene content is less than 50% by weight, and most preferably is less than 15% by weight. This does have a lower ethylene content than KOATTRO DP8310M, identified above.

Polybutene-1 copolymer is an optional component of the core, which contributes to the desired, high shrink performance within the temperature range requirement for heat shrink label applications (80-100° C.).

### VISTAMAXX and VERSIFY Copolymers

Propylene-based polyolefin elastomers (POE's) are commercially available from ExxonMobil Chemical Company under the trade name VISTAMAXX or Dow Chemical Company under the trade name VERSIFY.

Composition and structure: These POE's are semi-crystalline copolymers of propylene and ethylene with high propylene levels (>80 wt. %) with isotactic stereochemistry. Crystallinity is modulated by the ethylene content to 5-45% crystallinity complementary to a large amorphous fraction. These POE's also have the following properties: a narrow Molecular Weight Distribution (MWD), a MFR (230/2.16) in the range of 2 to 25 g/10 min, a density in the range of 0.863 to 0.891 g/cm³, a Glass Transition Temperature Tg in the range of 5 to −31° F. (−15 to −35° C.) and a Melting Range: of 122 to 248° F. (50 to 120° C.) and higher.

VISTAMAXX 3980FL: MFR (190/2.16) of 3.2 dg/min, ethylene content of 9%, density of 0.879 g/cm³, and Vicat softening point of 76.7° C.

VERSIFY 3000: MFR (230/2.16) of 8 dg/min, density of 0.88 g/cm³, melting point of 108° C., crystallinity=44%, and Vicat softening point of 52° C.

The propylene based POE, like the polybutene-1 copolymer, is an optional component of the core layer, which contribute to the desired, high shrink performance within the temperature range requirement for heat shrink label applications (80-100° C.).

### Other Additives

Other additives like slip agents, antiblock agents, UV adsorbers, colorants, anti-oxidants, and antacids can be used in the core layer and/or other layers of the film. When present in the core layer, additives preferably constitute 0.1-20 wt. %, 1-15 wt. % or 5-10 wt. % of the core layer.

White non-voiding opacifying pigments (TiO₂ concentrates) are commercially available from LyondellBasell, Houston, TX under the trade names POLYBATCH. Preferred are concentrates in a polypropylene carrier polymer. The following is a non-exclusive listing of exemplary TiO₂ concentrates that are, or that may be usable in the core layers of the films in this invention:

POLYBATCH White LL8006 CT, 70 wt. % TiO₂ in a polypropylene carrier. MFR of the concentrate (190° C., 2.16 kg is 6-11 g/10 min., and the concentrate is calcium stearate free.

POLYBATCH White 8000 EC, 70 wt. % TiO₂ in a polypropylene carrier. MFR of the concentrate (190° C., 2.16 kg is 2-6 g/10 min., and the concentrate is calcium stearate free.

The silica gel can be added to the polymer before the layers are combined in a die, which is generally referred to as a “masterbatch”. This is done to facilitate downstream blending and has a silica concentration equal to or greater than the concentration in the final film construction. This additional process step also improves particle dispersion in the polymer. Optionally, the silica gel can be added as a powder directly to the polymer before combining layers in the die.

The skin layers provide functions of printability, color, adhesion to adhesives or glues, management of friction, appearance (such as matte, satin or gloss), thermal sealability, and barrier to moisture or oxygen. Consequently, the selection of polymer and appropriate additives is large. While voiding in the thickest layer is typically the most effective to reducing film density, silica gel could also be present in the skin layer. Skin layers are typically 0.5 to 5 microns in thickness. The two skins may be similar or dissimilar depending on the specific application needs. The skins can also be treated with corona, plasma, or flame to affect the surface tension. The skin polymer can be any of the number of polyolefin based polymers and copolymers described or polyamide or EVOH as well.

The intermediate layer is optional, and is typically used to improve the bonding between the skin polymer and core polymer of the structure. This coextruded film layer can be an olefin copolymer comprising polar comonomers, such as, e.g., vinyl acetate, alkyl acrylates, alkyl methacrylates, acrylic acid or maleic anhydride. This layer may include, e.g., propylene homopolymer, copolymer or terpolymer, copolymers of alpha-olefins comprising ethylene or propylene co-monomers, propylene or ethylene elastomers, or mixtures thereof. Additionally, in certain embodiments, the intermediate layer may function to add mechanical stiffness to the film structure using polymers with higher modulus such as homopolymer polypropylene, alternatively with high crystallinity. The intermediate layer is typically 0.5 to 5 microns in thickness.

In accordance with this invention, the overall thickness of oriented films employed to form labels can preferably range from 10 microns to 100 microns, more preferably from 12 microns to 75 microns, and even more preferably from 40 microns to 65 microns. In the most preferred embodiments of this invention, the film is a multilayer film including a core layer between opposed skin layers. Film produced for flexible packaging ranges from 10 to 50 microns, most preferably between 15 and 40 microns.

The film surface can optionally be treated with corona, flame, and/or plasma to improve printability or adhesion.

The film surface can optionally be subsequently coated with common primers or coatings to achieve various functionalities.

### Labels

Another aspect of the invention is a label comprising the inventive film. The label is preferably a wash off label, and more preferably a roll on shrink on (ROSO) label.

### Flexible Package

Another aspect of the invention is a flexible package comprising the inventive film. The flexible package comprises at least one chamber for holding the contents of the package, such as food, pharmaceuticals, cosmetics, etc. The walls of the chamber comprise the inventive film. In preferred embodiments, the flexible package further comprises ink applied to an external surface or to an externally visible surface of the film.

### Method of the Invention

The inventive multilayer films are composed of two or more layers of different polymers, each contributing distinct properties to the final product. Sequential biaxial orientation involves stretching a multilayer film in two directions, both transverse and longitudinal, resulting in enhanced mechanical strength and barrier properties.

The design of the multilayer film involves determining the number and arrangement of layers, as well as their thickness ratios. The combination of different materials can yield synergistic effects, enhancing the overall performance of the film. The arrangement can be symmetric (e.g., A/B/A) or asymmetric (e.g., A/B/C). Each layer serves a specific purpose, such as enhancing barrier properties or improving mechanical strength.

The silica gel can be added as a powder to the specific layers of film immediately prior to extrusion into a multilayer cast sheet. However, more typically the silica gel is extrusion compounded with polymer to form what is called a “masterbatch”. Pellets of the masterbatch are easier to handle during the film formation process. The masterbatch has a silica gel concentration that is either equal or more commonly higher than the desired concentration in the film construction.

The process begins with extruding the polymers to create individual layers. In coextrusion, multiple extruders are used to simultaneously produce the different layers, which are then combined into a multilayer feedblock. The feedblock ensures precise layer arrangement and thickness control.

After extrusion, the multilayer casting is quenched using water bath or chill rolls at approximately 20 to 60 C. After quenching, an extrusion coating can be applied to the casting on one or both sides.

The cast multilayer film is then stretched in the machine direction (MD) at a preferred MD temperature of 100-150° C. or 120-130° C. The MD stretching is preferably several times the original MD dimensions, such as, e.g., 2×, 3×, 4×, 5× or 6× the original MD dimensions in this step.

The multilayer film is then stretched in the transverse direction (TD) at a preferred TD temperature of 150-180° C. or 160-170° C. This process step is generally performed in a tenter oven. The TD stretching is preferably several times the original TD dimensions, such as, e.g., 2×, 3×, 4×, 5×, 6×, 7×, 8×, 9×, 10× or 11× the original TD dimensions in this step.

The biaxially stretched film is heat-set to lock in the molecular orientation and stabilize the properties. Heat setting or annealing involves heating the film to a heat setting temperature (preferably 120 to 170° C.) and then cooling it while maintaining the stretched dimensions or relaxing the stretch 5 to 15%.

The invention will be illustrated in more detail with reference to the following Examples, but it should be understood that the present invention is not deemed to be limited thereto.

### EXAMPLES

### Materials and Methods

Density was determined by the displacement procedure of ASTM D 792 test method.

Opacity was measured using a Technidyne Corporation Opacitmeter Model BNL-3 (New Albany, IN) or similar device following ASTM D589.

Z-axis Strength is the measure of the interlaminar strength of a film specimen and covers measurement of the forces exerted when a specimen is pulled apart in the z direction perpendicular to the surface (i.e., through the cross section). Scotch 610 tape (1 inch width and 8 inches long) was applied to both sides of the film specimen with moderate pressure. To ensure z axis failure, the tape was initially pulled apart manually to initiate inter-laminate failure. Once the z-axis failure was initiated, the two tape tabs of the sample were placed in a MTS Q-Test/1 L tensile tester or similar instrument (25N cell) and separated at a cross head speed of 35 inches/min. The peak force was recorded and reported as g/in of width. If the sample did not initiate or fail by inter-laminate separation, it was reported as “could not delaminate”.

The materials used in the examples are summarized in Table 1 below.

TABLE 1

| | Raw | |
|---|---|---|
| Raw Material Generic | Material | |
| Description | Identification | Supplier Identification |
| Propylene ethylene Copolymer | R08G-00 | Eneos Inc.; (Schaumburg, IL) |
| 5% Precipitated silica | ABPP05SC | LyondellBasell; (Houston, TX) |
| masterbatch | | |
| Polypropylene | FF030F2 | Braskem Inc. (Philadelphia, PA) |
| 5% anti-block masterbatch | ABE20CP | LyondellBasell; (Houston, TX) |
| 60% TiO2 masterbatch | WP8266 | Washington Penn, (Washington, PA) |
| Silica Gel | Syloid C805 | Grace Davison, (Baltimore MD) |
| Propylene ethylene Copolymer | Total 6575 | TotalEnergies (Brussels, Belgium) |
| Propylene ethylene Copolymer | DPRG 70Q | Braskem Inc. (Philadelphia, PA) |
| 5% anti-block masterbatch | ABVT22NSC | LyondellBasell Inc. (Houston, TX) |
| Propylene ethylene Copolymer | DS6D21 | Braskem inc.(Philadelphia, PA) |
| 6% antiblock masterbatch | ABVT19NSC | LyondellBasell Inc. (Houston, TX) |
| 70% CaCO3 master batch | PF-97N | LyondellBasell Inc. (Houston, TX) |
| Polypropylene | Braskem 6025 | Braskem inc.(Philadelphia, PA) |
| Hard resin masterbatch | MA00929 | Constab Polyolefin Additives GmbH |
| | | (Negev Israel) |
| 60% TiO2 masterbatch | WP-8562 | Washington Penn, Philadelphia |
| | | Pennsylvania |
| Propylene ethylene Copolymer | DS6D82 | LyondellBasell Inc. (Houston, TX) |

Seventeen five-layer examples of sequentially stretched biaxially oriented films were produced. The materials used in each example are described below.

### Example 1—0.8% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 90.2% DS6D21 + 0.8% Syloid C 805 + 9% |
| | | WP8266 |
| 4 | 4.6 | 100% FF030F2 |
| 5 | 0.8 | 65% Total 6575 + 32% DPRG 70Q + 3% |
| | | ABVT22NSC |

### Example 2—3.0% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 88% DS6D21 + 3% Syloid C 805 + 9% WP8266 |
| 4 | 4.6 | 100% FF030F2 |
| 5 | 0.8 | 65% Total 6575 + 32% DPRG 70Q + 3% |
| | | ABVT22NSC |

### Example 3—4.4% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 80% DS6D21 + 4.4% Syloid C 805 + 9% WP8266 |
| 4 | 4.6 | 100% FF030F2 |
| 5 | 0.8 | 65% Total 6575 + 32% DPRG 70Q + 3% |
| | | ABVT22NSC |

### Comparative Example 1—1% Precipitated Silica

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 71% DS6D21 + 20% ABPP05SC + 9% WP8266 |
| 4 | 4.6 | 100% FF030F2 |
| 5 | 0.8 | 65% Total 6575 + 32% DPRG 70Q + 3% |
| | | ABVT22NSC |

### Comparative Example 2—3% Precipitated Silica

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 31% DS6D21 + 60% ABPP05SC + 9% WP8266 |
| 4 | 4.6 | 100% FF030F2 |
| 5 | 0.8 | 65% Total 6575 + 32% DPRG 70Q + 3% |
| | | ABVT22NSC |

### Comparative Example 3—4.55% Precipitated Silica

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 91% ABPP05SC + 9% WP8266 |
| 4 | 4.6 | 100% FF030F2 |
| 5 | 0.8 | 65% Total 6575 + 32% DPRG 70Q + 3% |
| | | ABVT22NSC |

### Comparative Example 4—1% Calcium Carbonate

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 89.5% DS6D21 + 9% WP8266 + 1.5% PF-97N |
| 4 | 4.6 | 100% FF030F2 |
| 5 | 0.8 | 65% Total 6575 + 32% DPRG 70Q + 3% |
| | | ABVT22NSC |

### Comparative Example 5—3% Calcium Carbonate

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 86.7% DS6D21 + 9% WP8266 + 4.3% PF-97N |
| 4 | 4.6 | 100% FF030F2 |
| 5 | 0.8 | 65% Total 6575 + 32% DPRG 70Q + 3% |
| | | ABVT22NSC |

### Comparative Example 6—5% Calcium Carbonate

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 84% DS6D21 + 9% WP8266 + 7% PF-97N |
| 4 | 4.6 | 100% FF030F2 |
| 5 | 0.8 | 65% Total 6575 + 32% DPRG 70Q + 3% |
| | | ABVT22NSC |

### Example 4—0.8% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 90.2% FF030F2 + 9% WP8266 + 0.8% Syloid C |
| | | 805 |
| 4 | 4.6 | 100% FF030F2 |
| 5 | 0.8 | 65% Total 6575 + 32% DPRG 70Q + 3% |
| | | ABVT22NSC |

### Example 5—3.0% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 88% FF030F2 + 9% WP8266 + 3% Syloid C 805 |
| 4 | 4.6 | 100% FF030F2 |
| 5 | 0.8 | 65% Total 6575 + 32% DPRG 70Q + 3% |
| | | ABVT22NSC |

### Example 6—4.4% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 86.6% FF030F2 + 9% WP8266 + 4.4% Syloid C |
| | | 805 |
| 4 | 4.6 | 100% FF030F2 |
| 5 | 0.8 | 65% Total 6575 + 32% DPRG 70Q + 3% |
| | | ABVT22NSC |

### Example 7—6% Silica Gel

| Film | Thickness | |
|---|---|---|
| Layer | (microns) | Layer Composition |
| 1 | 0.8 | 85% R08G-00 + 10% ABPP05SC + 5% ABE 20CP |
| 2 | 4.6 | 100% FF030F2 |
| 3 (Core) | 17.3 | 85% FF030F2 + 9% WP8266 + 6% Syloid C 805 |
| 4 | 4.6 | 100% FF030F2 |
| 5 | 0.8 | 65% Total 6575 + 32% DPRG 70Q + 3% |
| | | ABVT22NSC |

### Example 8—6% Silica Gel

| Film | Thickness | |
|---|---|---|
| Layer | (microns) | Layer Composition |
| 1 | 0.8 | 95% FF030F2 + 3% ABVT19NSC + 2% PF-97N |
| 2 | 3.5 | 90% Braskem 6025 + 7% MA00929 + 3% Ti-8562 |
| 3 (Core) | 30 | 60% Braskem 6025 + 6% Syloid C 805 + 34% |
| | | FF030F2 |
| 4 | 3.5 | 90% Braskem 6025 + 7% MA00929 + 3% |
| | | WP-8562 |
| 5 | 0.8 | 97% DS6D82 + 3% ABPP05SC |

### Example 9—8% Silica Gel

| Film | Thickness | |
|---|---|---|
| Layer | (microns) | Layer Composition |
| 1 | 0.8 | 95% FF030F2 + 3% ABVT19NSC + 2% PF-97N |
| 2 | 3.5 | 90% Braskem 6025 + 7% MA00929 + 3% |
| | | WP-8562 |
| 3 (Core) | 30 | 60% Braskem 6025 + 8% Syloid C 805 + 32% |
| | | FF030F2 |
| 4 | 3.5 | 90% Braskem 6025 + 7% MA00929 + 3% |
| | | WP-8562 |
| 5 | 0.8 | 97% DS6D82 + 3% ABPP05SC |

### Example 10—10% Silica Gel

| Film | Thickness | |
|---|---|---|
| Layer | (microns) | Layer Composition |
| 1 | 0.8 | 95% FF030F2 + 3% ABVT19NSC + 2% PF-97N |
| 2 | 3.5 | 90% Braskem 6025 + 7% MA00929 + 3% |
| | | WP-8562 |
| 3 (Core) | 30 | 50% Braskem 6025 + 10% Syloid C 805 + 40% |
| | | FF030F2 |
| 4 | 3.5 | 90% Braskem 6025 + 7% MA00929 + 3% |
| | | WP-8562 |
| 5 | 0.8 | 97% DS6D82 + 3% ABPP05SC |

### Example 11—12% Silica Gel

| Film | Thickness | |
|---|---|---|
| Layer | (microns) | Layer Composition |
| 1 | 0.8 | 95% FF030F2 + 3% ABVT19NSC + 2% PF-97N |
| 2 | 3.5 | 90% Braskem 6025 + 7% MA00929 + 3% |
| | | WP-8562 |
| 3 (Core) | 30 | 40% Braskem 6025 + 12% Syloid C 805 + 48% |
| | | FF030F2 |
| 4 | 3.5 | 90% Braskem 6025 + 7% MA00929 + 3% |
| | | WP-8562 |
| 5 | 0.8 | 97% DS6D82 + 3% ABPP05SC |

Using a pilot tenter, the five-layer structures were cast on a chill roll at 60° C. and then stretched in the machine direction 4.8× at a temperature from 124-130° C. The film was subsequently stretched in the transverse direction approximately 8.5× in a tenter oven at stretch temperatures of 162-168° C.

As a reference, two commercial films from Taghleef Inc. were chosen namely, ERD 35 (Comparative Example 7) and LMW-138 (Comparative Example 8). The film structures produced on the pilot tenter were chosen to align with these two commercial films. The ERD-35 offers the commercial market a voided opaque film with high z-axis strength. The LMW-1 38 offers the market the lowest density voided opaque label film.

The films were measured for selected tests such as density, opacity, and z-axis strength. Table 2 below summarizes the test results

TABLE 2

| | | | | | Z-axis |
|---|---|---|---|---|---|
| | Cavitating | Cavitant | Density | | Strength |
| | Agent | (%) | (g/cc) | Opacity | (g/in) |
| Example 1 | Silica Gel | 0.8 | 0.845 | 75 | |
| Example 2 | Silica Gel | 3.0 | 0.67 | 89 | |
| Example 3 | Silica Gel | 4.4 | 0.57 | 92 | |
| Comparative Ex. 1 | Precipitated | 1.0 | 0.925 | 54 | |
| | Silica | | | | |
| Comparative Ex. 2 | Precipitated | 3.0 | 0.95 | 58 | |
| | Silica | | | | |
| Comparative Ex. 3 | Precipitated | 4.55 | 0.925 | 43 | |
| | Silica | | | | |
| Comparative Ex. 4 | Calcium | 1.0 | 0.95 | 64 | |
| | Carbonate | | | | |
| Comparative Ex. 5 | Calcium | 3.0 | 0.95 | 58 | |
| | Carbonate | | | | |
| Comparative Ex. 6 | Calcium | 5.0 | 0.96 | 62 | |
| | Carbonate | | | | |
| Example 4 | Silica Gel | 0.8 | 0.84 | | 520 |
| Example 5 | Silica Gel | 3.0 | 0.68 | | 370 |
| Example 6 | Silica Gel | 4.4 | 0.57 | | 280 |
| Example 7 | Silica Gel | 6.0 | 0.51 | | 230 |
| Example 8 | Silica Gel | 6.0 | 0.47 | | |
| Example 9 | Silica Gel | 8.0 | 0.41 | | |
| Example 10 | Silica Gel | 10.0 | 0.34 | | |
| Example 11 | Silica Gel | 12.0 | 0.3 | | |
| Comparative Ex. 7 | Calcium | 9.7 | 0.74 | 83 | 346 |
| (ERD 35) | Carbonate | | | | |
| Comparative Ex. 8 | Calcium | 12.5 | 0.56 | 85 | 212 |
| (LMW1 38) | Carbonate | | | | |

Comparing Example 3 to the LMW-1 38 sample (Comparative Example 8) shows the unexpected impact of silica gel. Example 3 with only 4.4% loading as compared to 12.5% loading of calcium carbonate delivered higher whiteness and opacity at similar density.

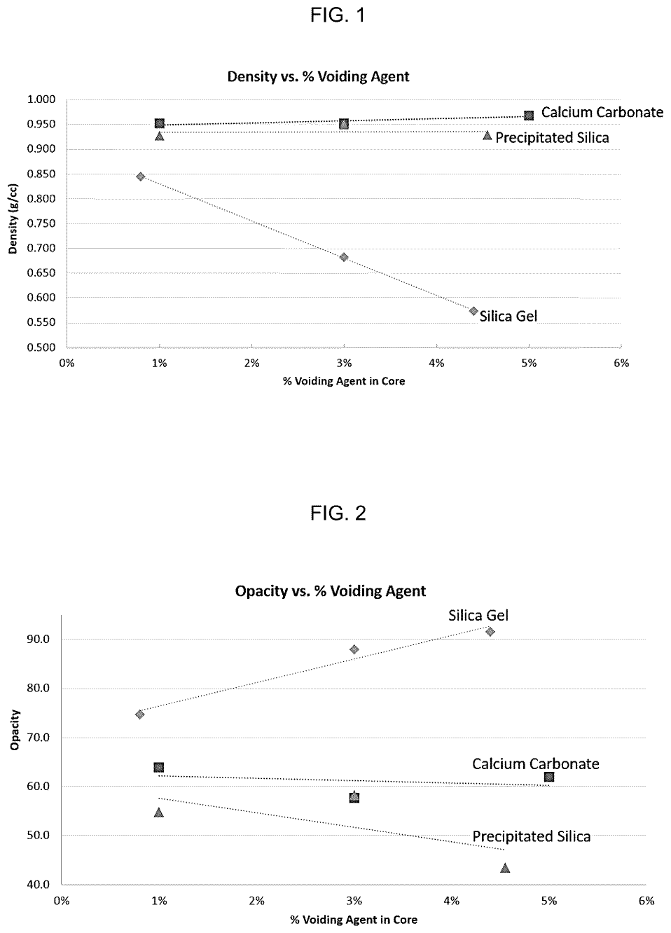

FIGS. 1-4 are based on selected data in Table 2 above.

In FIG. 1, the film density of the three voiding agents are shown as a function of percent voiding agent in the core. In the range of 1 to 5% calcium carbonate and precipitated silica show little impact on density. While silica gel shows the ability to reduce film density through voiding with as little as 1%.

FIG. 2 shows the unexpected impact of silica gel addition on achieving higher opacity at low loading levels as compared to calcium carbonate and precipitated silica.

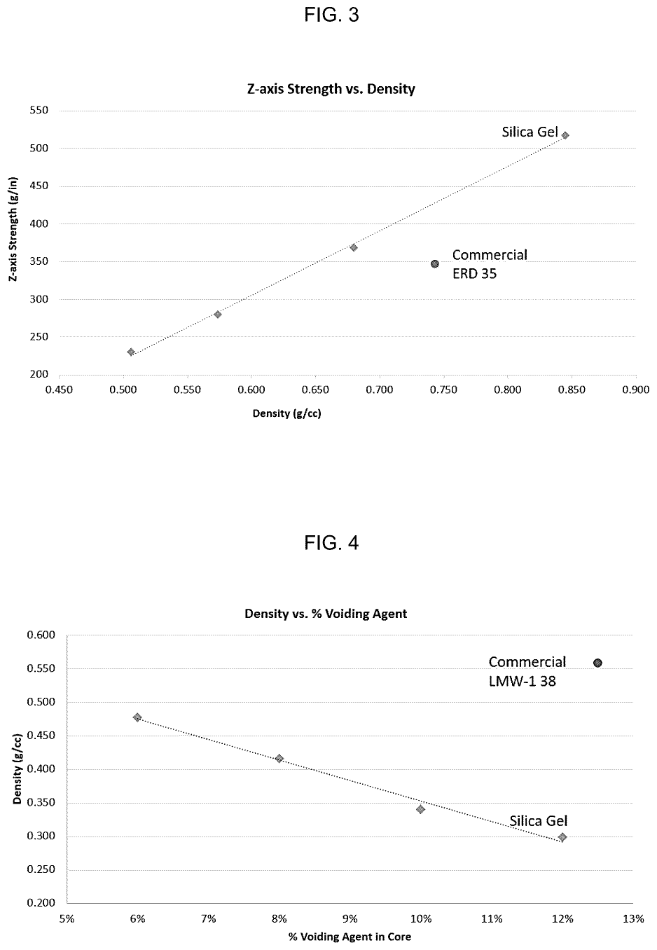

FIG. 3 shows the z axis as a function of density and the comparison to the properties achieved commercially. The commercial ERD-35 (Comparative Example 7) produced using calcium carbonate as a voiding agent had a z axis strength of 346 g/in at a density of 0.74 g/cc. This graph shows that equivalent z-strength could be achieved at only a density of 0.65 g/cc. Silica gel also offers the opportunity to increase z axis strength to 425 g/in at similar density to ERD-35.

FIG. 4 shows the ability of silica gel to enable lower density films. The graph shows the film density as a function of silica gel addition. A low density commercial film, LMW1 38 (Comparative Example 8) had a density of 0.555 g/cc using 12.5% calcium carbonate as a voiding agent. Using 12% silica gel enabled the production of a very low density film of only 0.3 g/cc with good mechanical properties. The graph also shows that the reduction in density is linear with the addition of silica gel. This suggests that higher addition will enable the production of even lower density films. This is in contrast to calcium carbonate, where it is known that a plateau in the ability to achieve lower density exists, because of the inherent high density of the voiding agent itself. The mass of the voiding agent starts to impede the impact of the void on achieving low density.

It was surprising that silica gel voids uniquely efficiently enabling higher strength voided material, lower density, and surprisingly high opacity and whiteness with relatively little mass. Films of the invention preferably have a density, an opacity and a z-axis strength within the ranges reported in Table 3 below.

TABLE 3

| Property | Range 1 | Range 2 | Range 3 |
|---|---|---|---|
| Density (g/cc) | 0.1-0.9 | 0.2-0.8 | 0.3-0.7 |
| Opacity | 65-100 | 70-95 | 80-90 |
| Z-axis Strength | 200-700 | 250-650 | 350-550 |

While the invention has been described in detail and with reference to specific examples thereof, it will be apparent to one skilled in the art that various changes and modifications can be made therein without departing from the spirit and scope thereof.

What is claimed is:

1. A multilayer film comprising a plurality of layers including a thickest layer comprising 1 to 25 wt. % of a silica gel having an average particle size of 1 to 10 microns, and at least 50 wt. % of at least one polyolefin, wherein: (a) the thickest layer is voided by the silica gel; and (b) the multilayer film is a sequentially stretched biaxially oriented film having an opacity greater than 10 and a density of less than 1 g/cc.

2. The multilayer film of claim 1, wherein the polyolefin is predominantly polypropylene.

3. The multilayer film of claim 1, wherein the at least one polyolefin is at least one member selected from the group consisting of polypropylene, polyethylene, polypropylene/polyethylene copolymer, polypropylene/polyethylene/polybutylene terpolymer, butene-1 copolymer with ethylene and styrenic triblock (S-E/B-S) copolymer elastomers.

4. The multilayer film of claim 1, having a density less than 0.85 g/cc.

5. The multilayer film of claim 1, having a z-axis strength greater than 100 g/in.

6. The multilayer film of claim 1, having a z-axis strength greater than 200 g/in and a density less than 0.7 g/cc.

7. The multilayer film of claim 1, having a z-axis strength greater than 400 g/in.

8. The multilayer film of claim 1, which is white with an opacity greater than 80, and the thickest layer contains 2-8 wt. % of the silica gel.

9. The multilayer film of claim 1, wherein the silica gel adsorbs less than 8% moisture at 80% relative humidity.

10. The multilayer film of claim 1, further comprising titanium dioxide.

11. The multilayer film of claim 1, comprising a combination of voiding agents including at least one additional voiding agent in addition to the silica gel, wherein an average density of the combination of voiding agents in the multilayer film is less than 1 g/cc.

12. The multilayer film of claim 1, wherein a surface thereof is treated or coated.

13. A label comprising the multilayer film of claim 1.

14. The label of claim 13, which is a wash off label.

15. The label of claim 13, which is a roll on shrink on (ROSO) label.

16. A flexible package comprising the multilayer film of claim 1.

17. The flexible package of claim 16, which is a bag having walls formed by the multilayer film.
